(19) United States
(12) Patent Application Publication
(10) Pub. No.: US 2023/0080959 A1
(43) Pub. Date: Mar. 16, 2023

(54) WOOD STAINS AND PENETRATION PRIMERS COMPRISING LOW VOC LEVEL AQUEOUS DISPERSIONS

(71) Applicant: Celanese International Corporation, Irving, TX (US)

(72) Inventors: Matthias JUNK, Hahnlein (DE); Thomas FICHTNER, Dalheim (DE)

(21) Appl. No.: 17/473,456

(22) Filed: Sep. 13, 2021

(51) Int. Cl. C09D 5/02; C09D 15/00; C09D 133/08

(52) U.S. Cl. CPC C09D 5/025; C09D 15/00; C09D 5/022; C09D 133/08; C08K 2201/019; C08K 5/5419

(57) ABSTRACT

Disclosed are stable penetration primer or wood stain formulations. The formulation may comprise a) an aqueous polymer dispersion comprising a polymer produced by free-radically initiated emulsion polymerization of at least one ethylenically unsaturated strong acid monomer with a pKa less than 4 (in water at 20° C.) and at least one ethylenically unsaturated weak acid monomer with a pKa of 4 or greater (in water at 20° C.); and b) at least one water-soluble alkali metal silicate, at least one water-soluble alkali metal or alkaline earth metal alkyl siliconate, or a mixture thereof.

### FIELD OF THE INVENTION

The present invention relates generally to wood stain and penetration primer formulations containing aqueous dispersions having low volatile organic component levels. Specifically, the aqueous dispersion comprises a polymer formed by polymerization of at least one ethylenically unsaturated strong acid monomer and at least one ethylenically unsaturated weak acid monomer. The formulation also includes at least one water-soluble alkali metal silicate, at least one water-soluble alkali metal or alkaline earth metal alkyl siliconate, or a mixture thereof.

### BACKGROUND OF THE INVENTION

Due to environmental and health concerns, there has been a movement towards reducing the amount of volatile organic compounds (VOCs) contained in primers, stains, and other coating compositions, which evaporate into the environment upon drying. Additives to primers and wood stains that facilitate or impart desirable properties, such as better film coalescence, better resistance to blocking, better durability, and tougher coatings, among others, also frequently contain VOCs. The evaporation of VOCs, for example during drying, often results in undesirable aromas. Moreover, exposure to fumes, particularly in areas that are not well ventilated, can pose health concerns.

Formulations with reduced VOC content, although generally more environmentally friendly, tend to be more susceptible to bacteria, algae, yeasts, fungi and other biological agents that thrive in aqueous environments. Such biological agents can grow in paint cans and containers, often imparting an unpleasant odor and rendering the formulations unusable for their intended purpose. Biological agents also can cause viscosity loss, discoloration, gassing, frothing, sedimentation and pH changes in the formulations. Additionally, certain biological agents, such as algae and molds, may grow on dried paint films covering walls or other substrates resulting in potential health issues.

Biocides, particularly isothiazolinones, are therefore frequently added to low VOC aqueous formulations to control the growth of biological agents. Some of these biocides may remain on the dried paint film to control algae and molds. However, isothiazolinone-based biocides are known to cause allergic contact dermatitis. As a result, there is increasing publicity and regulation, especially in Europe, towards the reduction or elimination of biocides in paints and coatings. This in turn has led to increasing interest in alternative methods of stabilizing paints against microbiological attack. One such method involves maintaining the paint at high pH values, e.g., sufficiently high to inhibit microbial growth, by incorporating an inorganic alkaline buffer, such as water glass. Various high pH formulations have been described in the art.

U.S. Pub. No. 2021/0002506 describes a biocide- and ammonia-free aqueous polymer dispersion obtained by radically initiated multi-stage emulsion polymerization and comprising particles comprising at least a first polymer phase formed from a monomer composition I and a second polymer phase from a different monomer composition II. The first polymer phase has a glass transition temperature below 20° C., and the second polymer phase has a glass transition temperature above 20° C., both as determined by differential scanning calorimetry according to ISO 16805. The polymer dispersion further comprises at least one water-soluble alkali metal silicate, at least one water-soluble alkali metal or alkaline earth metal alkyl siliconate, or a mixture thereof and has a pH of 10.0 or higher.

U.S. Pat. No. 7,789,959 describes coating compositions comprising at least one strongly basic agent to set a pH of at least 10, at least one selected vinyl ester copolymer, if desired, pigment and/or filler, and, if desired, further additives customary per se. The coating compositions can be stored without use of additional preservatives and can be used to coat substrates of all kinds.

U.S. Pat. No. 7,285,590 describes aqueous dispersions having a minimum film formation temperature no greater than about 50° C., that include a multi-stage emulsion polymer made by a process that includes a first polymerization stage, in which a first monomer mixture having a calculated glass transition temperature of at least about 50° C. is polymerized via free radical emulsion polymerization to obtain a first-stage emulsion polymer, and a second polymerization stage, in which a second monomer mixture, having a calculated glass transition temperature from about −30° C. to about 10° C., is polymerized via free radical emulsion polymerization, in the presence of the first-stage emulsion polymer. The dispersions are useful in a variety of coating compositions that exhibit improved block resistance.

U.S. Pat. No. 6,756,459 describes a binder composition for aqueous coatings that exhibits high gloss and superior corrosion resistance when applied to metal substrates comprising an aqueous emulsion copolymer, the copolymer including as polymerized units, at least one ethylenically unsaturated monomer and an ethylenically unsaturated strong acid monomer, such as phosphorus containing monomers, particularly phosphoethylmethacrylate; or salts thereof Also provided is a method for achieving high gloss and superior corrosion resistance of metal substrates by coating a substrate with an aqueous coating composition comprising the binders of the present invention and drying, or allowing to dry, the aqueous composition.

EP Patent No. 1297079 discloses a preservative-free dispersion paint consisting of 4-15 percent by weight polymer dispersion that is calculated as solid fraction, 10-55 percent by weight pigment and/or extender and a maximum of 2 percent by weight water glass as additive and fractions of water to complete 100 percent by weight. Said dispersion paint has the known and reliable processing properties of dispersion paints although no preservative is used.

DE 102014013455 discloses an improved, non-preservation dispersion-based emulsion paint based on siliconates for indoor and outdoor use with improved properties. The paint contains a) 2-30% polymer dispersion calculated as solids content b) 10-60% pigment and/or filler, c) 0.5-5% siliconate as an additive and d) 100% added amounts of water.

Despite the disclosure of some aqueous dispersions having low amounts of VOCs and biocides for paints, the quest for low VOC primers and wood stains, however, continues to be challenging. Accordingly, the need exists for stable aqueous polymer dispersions having low VOC and biocide content for use in primer and wood stain formulations.

### SUMMARY OF THE INVENTION

In some aspects, the disclosure relates to a penetration primer or wood stain formulation. The formulation comprises: a) an aqueous polymer dispersion comprising a polymer produced by free-radically initiated emulsion polymerization of an ethylenically unsaturated strong acid monomer with a pKa less than 4 (in water at 20° C.) and an ethylenically unsaturated weak acid monomer with a pKa of 4 or greater (in water at 20° C.); and b) at least one water-soluble alkali metal silicate, at least one water-soluble alkali metal or alkaline earth metal alkyl siliconate, or a mixture thereof. In some aspects, the formulation may be free of biocides. The formulation may have a pH from 10 to 12, preferably from 10.5 to 11.5. The weight-average particle size of the aqueous polymer dispersion may be less than 100 nm, preferably less than 80 nm, or more preferably less than 60 nm, as measured by capillary hydrodynamic fractionation.

The at least one ethylenically unsaturated strong acid monomer may be present in an amount from 0.5 to 5 wt. %, preferably from 0.7 to 4.5 wt. %, more preferably from 0.8 to 4.0 wt. %, most preferably from 1.0 to 3.5 wt. %, based on the weight of all monomers used in producing the polymer. In some aspects, the at least one ethylenically unsaturated strong acid monomer comprises a sulfonic acid or a salt thereof. In some aspects, the at least one ethylenically unsaturated strong acid monomer comprises vinyl sulfonic acid or 2-acrylamido-2-methylpropanesulfonic acid or an alkali metal or ammonium salt thereof. In some aspects, the at least one unsaturated strong acid monomer comprises 2-acrylamido-2-methylpropanesulfonic acid or an alkali metal or ammonium salt thereof. The ethylenically unsaturated weak acid monomer may be present in an amount from 1 to 10 wt. %, preferably from 1.5 to 8 wt. %, more preferably from 2 to 7 wt. %, most preferably from 2.5 to 6 wt. %, based on the weight of all monomers used in producing the polymer. In some aspects, the at least one ethylenically unsaturated weak acid monomer is selected from the group consisting of an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, and combinations thereof. In some aspects, the at least one ethylenically unsaturated weak acid monomer comprises methacrylic acid, acrylic acid, or combinations thereof. In some aspects, the ethylenically unsaturated weak acid monomer comprises at least two ethylenically unsaturated weak acid monomers.

The polymer may additionally be formed from at least one hard block-building monomer having a glass transition temperature of the corresponding homopolymer of greater than 25° C. and at least one soft block-building monomer having a glass transition temperature of the corresponding homopolymer of less than 25° C. The hard block-building monomer may comprise styrene or a combination of methyl methacrylate and styrene. The soft block-building monomer may comprise 2-ethylhexyl acrylate. In some aspects, the monomer mixture used to form the polymer does not comprise methacrylamide and/or acrylamide. The glass transition temperature of the polymer may be 15° C. or lower, preferably from −15° C. to 10° C., more preferably from −10 to 5° C., as determined by differential scanning calorimetry according to ISO 16805 (2005). The formulation may have a minimum film forming temperature of less than 5° C., preferably less than 1° C. The aqueous polymer dispersion may have a Total Volatile Organic Compound (TVOC) content less than 1800 ppm, preferably less than 1500 ppm, more preferably less than 1000 ppm, as determined by gas chromatography according to ISO 11890-2 (2020). The formulation may be free of organic solvent, plasticizer, and/or coalescent agent.

### DETAILED DESCRIPTION OF THE INVENTION

### Introduction

Described herein are aqueous dispersions as well as primer and wood stain formulations incorporating the aqueous dispersions. The aqueous dispersion comprises a polymer produced by free-radically initiated emulsion polymerization of an ethylenically unsaturated strong acid monomer with a pKa of less than 4 (as measured in water at 20° C.) and an ethylenically unsaturated weak acid monomer with a pKa of 4 or greater (as measured in water at 20° C.). Also described herein are formulations for penetration primers or wood stains, wherein the formulation comprises the aqueous dispersion in combination with a buffer, i.e., at least one water-soluble alkali metal silicate, at least one water-soluble alkali metal or alkaline earth metal alkyl siliconate, or a mixture thereof.

As described above, the pH of a penetration primer and/or wood stain formulation may be adjusted to be at a level where biocides are not needed. One problem with such formulations, however, is that the polymer in the aqueous dispersion may not be compatible with the buffer. This is particularly challenging for very finely dispersed polymer dispersions with a high internal surface area, as required for penetration primers and wood stains. Surprisingly and unexpectedly, the Inventors found that formulations containing (i) an aqueous dispersion of a polymer formed from a weak acid monomer and a strong acid monomer, and (ii) a water-soluble alkali metal silicate, a water-soluble alkali metal siliconate, an alkaline earth metal alkyl siliconate, or combinations thereof, were advantageously both stable and low in VOC content. The formulation may also be biocide-free but still capable of preventing growth of bacteria, algae, yeasts, fungi and other biological agents that thrive in an aqueous environment

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references, e.g., meaning “one or more,” unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

As used herein, the term “comprises” and variations thereof is open-ended, but for purposes of the specification and as support for future claim amendments, it should be understood as alternatively disclosing more restrictive language, such as “consisting essentially of” or “consisting of.”

As used herein, the term “biocide-free”, when used in relation to a formulation, means a formulation which contains less than 10 ppm by weight, preferably less than 5 ppm and most preferably no detectable amount, of a chemical preservative, such as the compounds listed as Product-Type 6 biocides in EU Biocidal Products Regulation (528/2012). In some embodiments, the present formulation may not be subject to labeling with the safety phase EUH 208, which is otherwise required for coating compositions using biocides. For example, the amount of a 3:1 mixture of 5-chloro-2-methyl-4-isothiazolin-3-one (CIT) and 2-methyl-4-isothiazolin-3-one (MIT) needs to be less than 1.5 ppm to avoid EUH 208 labeling. The term “biocide” does not include organic and inorganic bases, such as sodium or potassium hydroxide, used to raise the pH of the coating composition to at least 10.

Volatile Organic Content is defined according to the Directive 2004/42/CE of the European Parliament and The Council of The European Union and measured according to ISO 11890-2 (2020). Semi Volatile Organic Content is defined according to Commission Decision 2014/312/EU and measured according to ISO 11890-2 (2020).

### Aqueous Polymer Dispersions

The formulations described herein include an aqueous polymer dispersion system that contains polymer particles in disperse distribution as the disperse phase in an aqueous medium. The aqueous polymer dispersions can be prepared as monomer mixtures in an aqueous medium and then polymerized, for example through an emulsion polymerization, to produce the aqueous polymer dispersion. In some aspects, the emulsion polymerization process is a free radically initiated polymerization.

The monomer mixture of the aqueous dispersion, prior to polymerization, contains at least two monomers capable of polymerization. A first monomer may comprise at least one ethylenically unsaturated strong acid monomer with a pKa less than 4 (in water at 20° C.), referred to herein as a strong acid monomer. A second monomer may comprise at least one ethylenically unsaturated weak acid monomer with a pKa of 4 or greater (in water at 20° C.), referred to herein as a weak acid monomer.

Exemplary strong acid monomers include a sulfonic acid or a salt thereof, such as vinyl sulfonic acid and 2-acrylamido-2-methylpropanesulfonic acid or the alkali metal or ammonium salts thereof. In some aspects, the strong acid monomer comprises 2-acrylamido-2-methylpropanesulfonic acid or the alkali metal or ammonium salts thereof. The strong acid monomer may be present in an amount from 0.5 to 5 wt. %, e.g., from 0.7 to 4.5 wt. %, from 0.8 to 4.0 wt. %, from 1.0 to 3.5 wt. %, from 1.2 to 3.0 wt. %, or from 1.4 to 2.5 wt. %, based on the weight of all monomers used in producing the polymer.

Exemplary weak acid monomers include ethylenically unsaturated C₃-C₈ monocarboxylic acids, ethylenically unsaturated C₄-C₈ dicarboxylic acids, ethylenically unsaturated C4-C8 dicarboxylic acid anhydrides, and combinations thereof. Exemplary ethylenically unsaturated C₃-C₈ monocarboxylic acids include acrylic acid, methacrylic acid and crotonic acid. Exemplary ethylenically unsaturated C₄-C₈ dicarboxylic acids include maleic acid, fumaric acid, itaconic acid, and citraconic acid. In some aspects, the weak acid monomer comprises methacrylic acid, acrylic acid, or combinations thereof. In some aspects, the weak acid monomer comprises at least two weak acid monomers. The weak acid monomer may be present in an amount from 1 to 10 wt. %, e.g., from 1.5 to 8 wt. %, from 2 to 7 wt. %, from 2.5 to 6 wt. %, or from 3 to 5 wt. %, based on the weight of all monomers used in producing the polymer.

In some aspects, the sum of strong and weak acid monomers is from 3 to 10 wt. %, such as from 4 to 8 wt. %, e.g. from 5 to 7 wt. %, based on the weight of all monomers used in producing the polymer.

In some aspects, the monomer mixture of the aqueous dispersion, prior to polymerization does not comprise methacrylamide or acrylamide.

In some aspects, the polymer in the aqueous dispersion is additionally formed from at least one hard block-building monomer having a glass transition temperature of the corresponding homopolymer of greater than 25° C. and at least one soft block-building monomer having a glass transition temperature of the corresponding homopolymer less than 25° C.

The hard block-building monomer may be selected from vinyl esters of C₁ to C₂ carboxylic acids, methacrylic acid esters, vinyl aromatics, vinyl halogenides, and mixtures thereof. In some embodiments, In some embodiments, the at least one hard block-building monomer is selected from styrene, vinyltoluene, acrylonitrile, methacrylonitrile, methyl methacrylate, cyclohexyl methacrylate, isobornyl acrylate, isobornyl methacrylate, and mixtures thereof. In some aspects, the hard block-building monomer comprises styrene. In some aspects, the hard block-building monomer comprises styrene and methyl methacrylate.

The soft block-building monomer may be selected from acrylic and methacrylic acid esters, olefins, vinyl esters of C₃ to C₁₈ carboxylic acids and mixtures thereof. In some embodiments, the at least one soft block-building monomer is selected from ethyl acrylate, n-butyl acrylate, n-octyl acrylate, 2-octyl acrylate, 2-ethylhexyl acrylate, 2-ethylhexyl methacrylate, 2-propylheptyl acrylate, lauryl acrylate, isodecyl methacrylate, lauryl methacrylate, tridecyl acrylate and mixtures thereof. In some aspects, the soft block-building monomer comprises 2-ethylhexyl acrylate.

Optionally, the monomer mixture of the aqueous dispersion, prior to polymerization, may include additional functional monomers. Exemplary additional functional monomers may include ethylenically unsaturated silane co-monomers such as vinyl trialkoxy silanes or γ-(meth)acryloxypropyltrialkoxysilanes, ethylenically unsaturated glycidyl co-monomers such as glycidyl methacrylate, ethylenically unsaturated ureido co-monomers such as ureido methacrylate, ethylenically unsaturated carbonyl-functional monomers such as diacetone acrylamide or acetoacetoxyethyl methacrylate, and monomers with at least two non-conjugated ethylenically unsaturated groups. These monomers may each generally be present, if at all, in an amount of at most 5 wt. %, based on the weight of all monomers used in producing the polymer.

In some aspects, the weight-average particle size (d_{w}) of the aqueous polymer dispersion is less than 100 nm, e.g., less than 80 nm, or less than 60 nm, as measured by capillary hydrodynamic fractionation. Finely dispersed polymer dispersions are particularly advantageous for penetration primers and wood stains, as they are able to deeply penetrate into the substrate.

In some aspects, the polymer dispersions may be prepared under conditions to produce a polymer with a uniform glass transition temperature. In some aspects, the glass transition temperature of the polymer comprised in aqueous polymer dispersion is 15° C. or lower, e.g., from −15° C. to 10° C., or from −10 to 5° C., as determined by differential scanning calorimetry according to ISO 16805. The glass transition temperature may be selected so as to have a low enough value that a coalescent agent is not needed. Coalescent agents are known to be the main contributors to VOCs in coating applications and are therefore preferably excluded from the formulations and aqueous dispersions described herein.

In some aspects, the Brookfield viscosity of the aqueous polymer dispersion may be less than 500 mPa s, e.g., less than 200 mPa s, or less than 100 mPa s, as measured at 20° C., 20 rpm, spindle 2.

In some aspects, the coagulum content of the unfiltered aqueous polymer dispersion may be less than 0.05%, e.g., less than 0.02%, less than 0.01%, or less than 0.005% as determined by filtration over a filter with 180 μm mesh size.

The aqueous polymer dispersion disclosed herein may be prepared by a customary processes of emulsion polymerization, where the monomers may be emulsified in the aqueous phase in the presence of emulsifiers, initiators, and optionally protective colloids, and are advantageously polymerized at temperatures from 60° C. to 95° C. These processes are familiar to those skilled in the art and may be carried out by batch processes, metered-monomer processes, or emulsion-feed processes. The emulsion-feed process allows a small amount of the monomers to be pre-polymerized and then the remainder of the monomers is metered in the form of an aqueous emulsion. The process may involve polymerization in one, two, and more stages with different monomer combinations. Preferably, a single stage polymerization is performed, producing a homogeneous polymer dispersion with one defined glass transition temperature.

The initiators may include, without limiting the scope of the embodiments of the disclosed invention, one or more free radical initiators. Suitable free radical initiators include hydrogen peroxide, benzoyl peroxide, cyclohexanone peroxide, isopropyl cumyl hydroperoxide, persulfates of potassium, persulfates of sodium and persulfates of ammonium, peroxides of saturated monobasic aliphatic carboxylic acids having an even number of carbon atoms and a C₈-C₁₂ chain length, tert-butyl hydroperoxide, di-tert-butyl peroxide, diisopropyl percarbonate, azoisobutyronitrile, acetylcyclohexanesulfonyl peroxide, tert-butyl perbenzoate, tert-butyl peroctanoate, bis(3,5,5-trimethyl)hexanoyl peroxide, tert-butyl perpivalate, hydroperoxypinane, p-methane hydroperoxide. The above-mentioned compounds can also be used within redox systems, using transition metal salts, such as iron(II) salts, or other reducing agents. Alkali metal salts of oxymethane sulfonic acid, hydroxylamine salts, sodium dialkyldithiocarbamate, sodium bisulfite, ammonium bisulfite, disodium 2-hydroxy-2-sulfonic acetic acid, disodium 2-hydroxy-2-sulfonic acetic acid, sodium dithionite, diisopropyl xanthogen disulfide, ascorbic acid, tartaric acid, and isoascorbic acid can also be used as reducing agents.

Based on the content of polymer, the polymer dispersions preferably comprise no more than 5 wt. %, such as from 1 to 4 wt. % of ionic emulsifiers, and no more than 5 wt. %, e.g., no more than 3 wt. %, such as no more than 2.5 wt. %, of nonionic emulsifiers, based on the total weight of all monomers used in forming the polymer in the aqueous dispersion.

Examples of suitable nonionic emulsifiers are alkyl polyglycol ethers, e.g., ethoxylation products of fatty alcohols such as lauryl, oleyl, or stearyl alcohol, or mixtures of the same, e.g., coconut fatty alcohol, or ethoxylation products of oxo-process alcohols; and ethoxylation products of polypropylene oxide. Also, copolymerizable nonionic surfactants can be employed. Particularly suitable are ethylene oxide ethers with a degree of ethoxylation from 20 to 40 of C₁₀ to C₁₈ alkyl alcohols. Preferably, no alkylphenol ethoxylates are used.

Suitable ionogenic emulsifiers are anionic emulsifiers, e.g., the alkali metal or ammonium salts of alkyl-, aryl- or alkylaryl sulfonates or -phosphonates, or of alkyl, aryl, or alkylaryl sulfates, or of alkyl, aryl, or alkylaryl phosphates, or compounds with other anionic end groups, and it is also possible here for there to be oligo- or polyethylene oxide units between the hydrocarbon radical and the anionic group. Typical examples are sodium lauryl sulfate, sodium undecyl glycol ether sulfate, sodium lauryl diglycol sulfate, sodium tetradecyl triglycol sulfate, sodium dodecylbenzenesulfonate. Also, copolymerizable anionic surfactants may be used. Sodium lauryl sulfate is particularly preferred. Preferably, no alkylphenol ethoxylates including derivatives thereof are employed.

In some embodiments, the polymer dispersions and compositions containing such dispersions described herein can be substantially free of protective colloids as stabilizing agents. Examples of protective colloids include carboxymethyl cellulose (CMC), hydroxyethyl cellulose (HEC), and polyvinyl alcohol (PVOH). Such polymer dispersions are considered to be “substantially free” of protective colloids when protective colloids comprise no more than 0.5 wt. %, e.g., no more than 0.2 wt. % or no more than 0.1 wt. %, based on the total amount of monomers used in forming the polymer in aqueous dispersion.

On completion of the polymerization, a further, preferably chemical after-treatment, especially with redox catalysts, for example combinations of the above-mentioned oxidizing agents and reducing agents, may follow to reduce the level of residual unreacted monomer on the product. In addition, residual monomer can be removed in known manner, for example by physical demonomerization, i.e. distillative removal, especially by means of steam distillation, or by stripping with an inert gas. In some aspects, the total residual monomer content of the polymer dispersion may be less than 500 ppm, e.g. less than 300 ppm, preferably less than 200 ppm, or less than 100 ppm as determined by gas chromatography according to ISO 11890-2 (2020).

Only polymerizable VOCs can be reduced through chemical after-treatment. It is hence important to minimize the amount of non-polymerizable VOC, which stem from by-products of monomers or other components utilized to manufacture the dispersion or which are generated during polymerization. As found by the Inventors, the combination of weak acid monomer and strong acid monomer allows for the formation of a polymer dispersion, which is compatible with high pH buffers such as alkali metal silicates and alkali metal or alkaline earth metal alkyl siliconates and that has a Total Volatile Organic Compound (TVOC) content of less than 1800 ppm, e.g., less than 1500 ppm, less than 1250 ppm or less than 1000 ppm, as determined by gas chromatography according to ISO 11890-2 (2020), without the need for time-consuming and costly physical demonomerization processes.

The aqueous polymer dispersions produced by the process described herein generally have a solids content of from 25 to 50% by weight, preferably from 30 to 40% by weight, and a pH between 2.5 and 9.0, preferably between 3.0 and 8.0, more preferably between 4.5 and 7.0. The pH value of the dispersion may be raised by addition of an organic or inorganic base, such as an amine or an alkali metal hydroxide, such as sodium or potassium hydroxide. In some embodiments, it is preferred to effect neutralization with a nitrogen-free base.

The aqueous polymer dispersions described herein are usually free of ammonia. They may also be free of biocides. In other embodiments, to increase the shelf life of the polymer dispersions, biocides may be added that can be decomposed during subsequent preparation of the coating composition to yield a preservative-free coating. For example, 2,2-dibromo nitrilopropionamide (DBNPA) readily decomposes at pH values above 7. 5-chloro-2-methyl-3(2H)-isothiazolone (CIT) can be decomposed either through increase of the pH, preferably to at least 11, or by addition of, e.g., cysteine to the coating composition. In some embodiments, the polymer dispersions may comprise up to 50 ppm CIT and up to 1000 ppm DBNPA. Preferably, the dispersions comprise a mixture of 5 to 14.9 ppm CIT and 50 to 500 ppm DBNPA. More information on a biocide treatment and removal process that allows aqueous polymer dispersions to be protected from microbial attack during storage, while allowing the end product, such as a coating composition, remain substantially preservative-free can be found in U.S. Patent Application Ser. No. 62/741,137 filed Oct. 4, 2018, the entire contents of which are incorporated herein by reference.

### Penetration Primer and Wood Stain Formulation

As described herein, the aqueous polymer dispersion may be combined with a high pH buffer, e.g., at least one water-soluble alkali metal silicate, at least one water-soluble alkali metal or alkaline earth metal alkyl siliconate, or a mixture thereof, to form a penetration primer and/or wood stain formulation.

The buffer is included to stabilize the pH of the formulation above a value of 10.0, preferably in the desired range. Water-soluble alkali metal silicates, also known as water glass or liquid glass, are described by the chemical formula M₂O×n SiO₂, where M can be lithium, sodium or potassium, and where n can range between 1-4. Preferably, alkali metal silicates with n>3.2 are used. In some aspects, the alkali metal silicate is potassium silicate.

Due to the ease of handling and mixing, aqueous solutions of alkali metal silicates may be used, particularly those with a solid content not exceeding 40 wt. %.

In addition to or instead of water-soluble alkali metal silicates, water-soluble alkali metal or alkaline earth metal alkyl siliconates, such as sodium, potassium or calcium methyl siliconate, can be used. An exemplary siliconate is potassium methyl siliconate. Due to the ease of handling and mixing, aqueous solutions of siliconates may be used.

Additionally, preparations comprising alkali metal silicates and/or alkali metal or alkaline earth metal alkyl siliconates, such as Lopon® PHB, marketed by ICL, may be used. In some aspects, the buffer comprises potassium silicate.

The formulation may comprise, based on the total weight of the formulation, from 0.1 to 4 wt. %, e.g., from 0.3 to 3 wt. %, from 0.5 to 2.5 wt. %, or from 0.7 to 2 wt. % of at the least one water-soluble alkali metal silicate, the at least one water-soluble alkali metal or alkaline earth metal alkyl siliconate, or a mixture thereof. If a water-soluble alkali metal silicate is used, preferred ranges are, based on the total weight of the formulation, 0.5 to 3 wt. %, e.g., 0.75 to 2.5 wt. %, such as 1 to 2 wt. %. If a water-soluble alkali metal or alkaline earth metal alkyl siliconate is used, preferred ranges are, based on the total weight of the formulation, 0.3 to 2 wt. %, e.g. 0.5 to 1.5 wt. %, such as 0.75 to 1 wt. %.

The at least one water-soluble alkali metal silicate, at least one water-soluble alkali metal or alkaline earth metal alkyl siliconate, or a mixture thereof, is preferably added to the polymer dispersion after polymerization. In some aspects, it may be post-added below 50° C.

The formulation may have a pH from 10 to 12, e.g., from 10.5 to 11.5, preferably from 11.0 to 11.5. The pH may be adjusted by the amount of buffer included, as described above. The pH value of the formulations may further be adjusted by addition of an organic or inorganic base. The formulation may be biocide-free. If the polymer dispersion comprises the biocide 5-chloro-2-methyl-3(2H)-isothiazolone (CIT), it can be removed through increase of the pH to high values, preferably above 11, or by addition of cysteine or other suitable additives, such as N-acetyl cysteine, mercaptoethanol, mercaptopropionic acid, methyl mercaptopropionate, glutathione, thioglycolate, sodium thiosulfate, sodium bisulfite, pyrithione, mercaptopyridine, dithiothreitol, mercaptoethanesulfonate, and/or sodium formaldehyde sulfoxylate to the coating composition, with cysteine being preferably used. Polymer dispersions comprising 2,2-dibromo-3-nitrilopropionamide (DBNPA) do not require addition of any decomposition agents, since DBNPA readily decomposes at pH values above 7.

Main contributors to VOC are coalescent agents which reduce the MFFT, such as butyl glycol, butyl diglycol, butyl diglycol acetate, 1-methoxy-2-propanol, 3-methoxy-1-butanol, texanol, ethyl diglycol, dipropylene glycol monomethyl ether, and dipropylene glycol n-butyl ether, and plasticizers, which increase the elasticity of the coating, such as 2,2,4-trimethyl-1,3-pentanediol diisobutyrate (TXIB), hexylene glycol, triethylene glycol-bis-2-ethylhexanoate (3G8), Loxanol® PL 3060, and Benzoflex™. Further VOC sources may include co-solvents, including glycols, which help with wet edge application, open time, and freeze-thaw resistance, emulsion components and most additives at low levels. For instance, amino methyl propanol is a volatile compound used to adjust pH. Accordingly, the formulation may also be free of organic solvent, plasticizer, and/or coalescent agents, i.e., does not contain a detectable amount of any or all of these components.

In some aspects, the polymer dispersion may have a minimum film forming temperature (MFFT) of less than 5° C., e.g., less than 1° C. The aqueous polymer dispersions described herein are stable fluid systems which can be used to produce formulations suitable for use as penetration primers and wood stains. The solid content of these formulations may range from 1 to 30%, e.g., from 5 to 25%, or from 10 to 20%.

The formulation may also comprise other components, including wetting agent, defoamer, hydrophobic agent, wood protection additive, pigments, thickener, dispersing agent/stabilizer, and combinations thereof. These components may each generally be present, if at all, in an amount from 0 to 5 wt. %, based on the total weight of the formulation.

The formulations may further comprise stabilizers, that prevent premature silicification of the silicate of siliconate buffers. Suitable stabilizers are organic compounds comprising the functionalities of primary, secondary or tertiary amines or quarternary ammonium salts.

Preferred pigment volume concentrations (pvc) of the formulations are below 30%, such as below 20%, preferably below 10%.

The penetration primer and/or wood stain formulations described herein may be applied to a variety of substrates, including hard and soft wood, gypsum, cement, fiberboard, melamine, drywall, old paint and render surfaces, and other building materials.

### EXAMPLES

### Example 1 (Comparative)

A 3 liter reactor equipped with a reflux condenser and an anchor stirrer was filled with 630 g of deionized (DI) water and 93.3 g of an aqueous sodium dodecylsulfate solution with an active content of 15 wt. %. While stirring, the reactor content was heated to 80° C. and 8.0% of the monomer feed was added, as obtained by mixing the ingredients in Table 1 under stirring. A solution of 0.7 g sodium persulfate in 14 g of DI water was added and the reactor contents were held at 80° C. for 15 min. Subsequently, the remaining amount of the monomer feed was added to the reactor with a constant dosage rate over 180 min. In a parallel feed, 2.1 g sodium persulfate in 70 g of DI water was added to the reactor with a constant dosage rate over 180 min. The reactor temperature was maintained at 80° C. during the feed additions. After completion of the feed additions, the reactor content increased to 85° C. for another 60 minutes. During the post-heating time, 0.7 g sodium persulfate in 35 g of DI water was slow-added within 15 min. Thereafter, 0.35 g sodium metabisulfite in 35 g of DI water was slow-added within 15 min. After cooling the reactor content to 70° C., 42 g of caustic soda (active content: 5 wt. %) were added. At 50° C., 0.8 g tert-butylhydroperoxide (TBHP, 70 wt. % in water) in 10.5 g DI water were added to the reactor. Subsequently, 0.5 g of Bruggolit® FF6 M (supplied by L. Bruggemann GmbH & Co. KG) in 10.5 g DI water were added within 15 min. After a waiting time of 10 min, the redox post-treatment was repeated. The reactor contents were then cooled to 30° C. The pH of the resulting polymer dispersion was then adjusted to about 6.0 with caustic soda (active content: 5 wt. %). Finally, 0.34 g Byk-1724 (supplied by Byk-Chemie GmbH) in 7 g of DI water, a solution of 1.1 g Acticide DB 20 (supplied by Thor GmbH, comprising 20 wt. % of 2,2-dibromo-3-nitrilopropionamide) in 7 g of DI water and 2.2 g Acticide® MV 1 (supplied by Thor GmbH, comprising 1.1 wt. % of 5-chloro-2-methyl-1,2-thiazol-3(2H)-one) in 7 g DI water were added to the dispersion.

The properties of the resulting polymer dispersion are summarized in Table 2.

TABLE 1
Compositions of the monomer feed (in grams)

| Example¹ | C1 | 2 | 3 | 4 | 5 | 6 | 7 | C8 |
|---|---|---|---|---|---|---|---|---|
| DI water | 560 | 560 | 560 | 560 | 560 | 560 | 560 | 560 |
| Sodium dodecyl sulfate, | 70 | 70 | 70 | 70 | 70 | 70 | 70 | 70 |
| 15 wt. % in water | | | | | | | | |
| Undecylethoxylate | 25 | 25 | 25 | 25 | 25 | 25 | 25 | 25 |
| with 28 mol EO, | | | | | | | | |
| 70 wt. % in water | | | | | | | | |
| Methacrylic acid (high pks) | 28 | 14 | 21 | 28 | 21 | 18 | 14 | 28 |
| Acrylic acid (high pks) | 0 | 14 | 7 | 0 | 7 | 10 | 7 | 0 |
| Methacrylamide | 0 | 0 | 0 | 0 | 0 | 0 | 0 | 14 |
| Sodium 2-acrylamido-2- | 0 | 21 | 28 | 28 | 28 | 28 | 35 | 0 |
| methylpropane-sulfonate, | | | | | | | | |
| 50 wt. % in water (counter ion of | | | | | | | | |
| strong acid) | | | | | | | | |
| Styrene | 315 | 154 | 154 | 154 | 119 | 137 | 154 | 154 |
| Methyl methacrylate | 0 | 154 | 154 | 154 | 119 | 137 | 154 | 154 |
| n-Butyl acrylate | 0 | 0 | 0 | 0 | 462 | 213 | 0 | 0 |
| 2-Ethylhexyl acrylate | 385 | 392 | 392 | 392 | 0 | 213 | 392 | 392 |

¹Comparative examples are marked with a ‘C’

### Examples 2-7 (Inventive)

The process of Example 1 was repeated with varying monomer feed compositions, as described in Table 1.

The properties of the resulting polymer dispersions are summarized in Table 2.

### Example 8 (Comparative)

The process of Example 1 was repeated with a varying monomer feed composition, as described in Table 1.

The properties of the resulting polymer dispersion are summarized in Table 2.

TABLE 2
Properties of the polymer dispersions

| Example | C1 | 2 | 3 | 4 | 5 | 6 | 7 | C8 |
|---|---|---|---|---|---|---|---|---|
| Solid content (%)¹ | 32.5 | 32.5 | 33.0 | 32.9 | 32.7 | 32.6 | 32.1 | 33.4 |
| Brookfield viscosity (mPa s)² | 20 | 30 | 32 | 28 | 26 | 32 | 32 | 22 |
| PH | 6.0 | 5.8 | 5.7 | 5.8 | 5.9 | 5.7 | 6.0 | 6.3 |
| Grit content (%)³ | 0.071 | 0.002 | 0.001 | 0.001 | 0.002 | 0.001 | 0.000 | 0.018 |
| dw (nm)⁴ | 52 | 43 | 45 | 45 | 45 | 46 | 47 | 48 |
| T_{g} (° C.)⁵ | 1.5 | −1.7 | −1.3 | −2.0 | −0.7 | −1.5 | −3.2 | 0.9 |
| TVOC (ppm)⁶ | 1129 | 994 | 1139 | 1085 | 745 | 949 | 1100 | 1921 |
| Σ residual monomers (ppm)⁷ | 17 | 58 | 65 | 69 | 49 | 51 | 96 | 43 |

¹Gravimetric determination after 24 hours drying at 110° C.
²Measurement conditions: 20° C., 20 rpm, spindle 2
³as determined by filtration over a filter with 180 pm mesh size
⁴Weight-average particle diameter as determined by capillary hydrodynamic fractionation (CHDF)
⁵Glass transition temperature (T_{g}) as measured by differential scanning calorimetry (DSC) according to ISO 16805 (2005)
⁶Total Volatile Organic Compound (TVOC) content as determined by gas chromatography according to ISO 11890-2 (2020)
⁷Sum of residual monomers as determined by gas chromatography according to ISO 11890-2 (2020)

As evident from Table 2, all inventive examples 2-7 comprising at least one strong acid monomer and one weak acid monomer exhibited a very low coagulum level <0.01%. Comparative example C1 suffers from a high coagulum content (0.07%). The grit content of comparative example C8 is only slightly increased (0.018%). More severely, this dispersion was prone to a very high TVOC content of 1921 ppm, which was about twice as high as the total amount of volatile organic compounds of all inventive dispersions (745-1139 ppm). Penetration primers with a low emission profile cannot be obtained based on this dispersion.

Commercially available biocide-free paints and coatings are usually protected against microbial attack through high pH values of greater 10, preferably greater 11. Commonly, inorganic alkaline buffers are added to raise and keep the pH value high enough to inhibit microbial growth during storage of the coatings. One commonly used buffer is water glass, being an aqueous solution of potassium silicate in water. To test the silicate compatibility of the dispersions as per. Ex. 1-8, they were admixed with water and Betolin K 28 (potassium silicate, 28 wt. % in water, supplied by Wöllner GmbH) in a 1:1:1 ratio by weight.

Comparative dispersion C1 (not comprising a strong acid monomer) coagulated during the mixing process, indicating inadequate silicate stability. Comparative dispersion C8 (not comprising a strong acid monomer) and inventive dispersion 5 (not comprising 2-ethylhexyl acrylate) could be admixed with potassium silicate without issues but coagulated after one day, indicating a limited silicate compatibility of these dispersions. Inventive dispersions 4 (comprising one weak acid monomer) and 6 (comprising a mixture of n-butyl acrylate and 2-ethylhexyl acrylate) solidified 7 days after being admixed with potassium silicate, indicating a slight silicate incompatibility. All other dispersions, besides being prone to slight speck formation 1 day after admixture of potassium silicate, did not show any silicate incompatibility under the harsh test conditions.

TABLE 3
Silicate compatibility

| | Evaluation | | |
|---|---|---|---|
| Example | Start | after 1 day | after 7 days |
| C1 | coagulated | | |
| E2 | ok | specks | specks |
| E3 | ok | specks | specks |
| E4 | ok | specks | solidified |
| E5 | ok | coagulated | |
| E6 | ok | specks | solidified |
| E7 | ok | specks | specks |
| C8 | ok | coagulated | |

### Examples 9-32 (Inventive and Comparative Penetration Primers)

Conventional biocide-containing penetration primers were prepared by mixing the ingredients in Table 4 (pos. 1-3 and 5) at room temperature under stirring (Ex. 9-16). Biocide-free penetration primers were obtained through addition of potassium methyl siliconate (pos. 6) and consecutive adjustment of the pH of the primers to 11.0-11.5 through addition of 10 wt. % caustic soda (Ex. 17-24). At this high pH range, the biocides added to the polymer dispersion readily decomposed (cp. WO 2020072206 A1) while the primers were protected against microbial attack through their high pH values.

A second class of biocide-free primers was obtained by mixing pos. 1, 4, 5, and 7 (Ex. 25-32). In this case, high pH values above 11 were affected through addition of potassium silicate (pos. 7).

TABLE 4
Compositions of the penetration primers

| | | | Biocide- | | |
|---|---|---|---|---|---|
| | | | containing | Biocide-free | Biocide-free |
| | | | primer | primer 1 | primer 2 |
| | | | (Ex. 9-16) | (Ex. 17-24) | (Ex. 25-32) |
| Pos. | Ingredient | Supplier | parts per weight | | |
| 1 | Water | | 585 | 585 | 537 |
| 2 | Calgon ® N¹, 10% in water | ICL | 10 | 10 | |
| 3 | Byk-1724² | Byk | 1 | 1 | |
| 4 | Tego ® Foamex 805 N² | Evonik | | | 2 |
| 5 | Dispersion per Ex. 1-8³ | | 404 | 404 | 391 |
| 6 | Silres ® BS 168⁴ | Wacker | | 18 | |
| 7 | Betolin K 28 | Wöllner | | | 70 |

¹dispersing agent, sodium polyphosphate
²defoamer, aqueous emulsion of siloxane polymers
³The solid contents of all polymer dispersions were adjusted to 32.0% before their addition.
⁴potassium methyl siliconate, 55 wt. % in water

### Application Tests

The penetration of each primer formulation into different substrates (gypsum, spruce, red cedar) was tested. Spruce was selected as a representative of soft wood. Red cedar was used as a representative of hard wood. 0.3 mL of primer was dripped onto the surface of each test substrate. After a waiting time of one hour, the penetration was assessed visually with a score from 1 to 6, 1 representing the best and 6 representing the worst rating. The scoring methodology was as follows: 1=full penetration, no gloss, no material visible on the surface; 2=full penetration, slight gloss at the edges, small amount of material visible at the edges; 3=approximately 50% of the material not penetrated, gloss at the edges, significant amount of material visible at the edges; 4=approximately 70% of the material not penetrated, gloss at the edges, significant amount of material visible at the edges; 5=more than approximately 70% of the material not penetrated, gloss visible on the entire drop surface, a crater is still visible in the center; 6=no penetration, material stays completely on the surface, gloss visible on the entire drop surface, no crater in the center.

Each primer was also tested regarding its ability to solidify quartz sand. The higher the solidification capability, the higher the binding capacity of the primer. For this test, a beaker was filled with quartz sand (W10 from Quarzwerke Frechen, Germany) which was then compacted by repeated, gentle tapping of the beaker on the bench. A defined hollow with a diameter of approximately 30 mm was created by pressing a spherical plastic stamp into the quartz surface. 2 mL of the primer were added dropwise into this hollow. After a drying time of 1 day, the solidified quartz sand body was taken out of the beaker, carefully freed from any loose sand with a brush, and weighed. The higher the weight, the better the solidification capability of the primer.

The pH stability of the biocide-free primers was tested as well. Since a sufficiently high pH is required for effective microbial protection of the primers, low pH stability is indicative of a limited shelve life of the biocide-free primers. The samples were stored at elevated temperature (50° C.) to accelerate chemical processes and to limit storage time.

### Application Results

The application results of the biocide-containing penetration primers are depicted in Table 5. With exception of the penetration of C9 based on Comparative Dispersion 1 into red cedar, the penetration performance of all primers was on an acceptable or better level. Examples C13-C15 even display excellent penetration into all tested substrates. Likewise, the solidification capability of all samples was on a very good level, i.e., significantly higher than 10 g. The results demonstrate that the inventive dispersions also performed well in conventional biocide-containing primers at pH values of about 7.

TABLE 5
Properties of the biocide-containing penetration primers

| | Disp. | | | | Solidification |
|---|---|---|---|---|---|
| | as per | Penetration into | | | of quartz |
| Primer | Ex. | gypsum | spruce | red cedar | sand (g) |
| C9 | C1 | 1 | 3 | 4.5 | 13.2 |
| C10 | 2 | 1 | 2 | 2 | 13.4 |
| C11 | 3 | 1 | 2 | 3 | 12.8 |
| C12 | 4 | 1 | 1 | 2.5 | 12.0 |
| C13 | 5 | 1 | 1 | 1 | 12.1 |
| C14 | 6 | 1 | 1 | 1 | 11.5 |
| C15 | 7 | 1 | 1 | 1 | 12.6 |
| C16 | C8 | 1 | 2 | 2 | 13.6 |

Application results of the ‘type 1’ biocide-free penetration primers (high pH affected through addition of potassium methyl siliconate) are displayed in Table 6. Due to the limited compatibility of Comparative Dispersion 1 with potassium methyl siliconate, primer C17 suffered from agglomerate formation during its preparation. After filtration of this primer to remove the agglomerates, the primer was subjected to all application tests. The penetration results for all samples were on a good or very good level. Likewise, the solidification capability of all samples was on an excellent level, almost consistently exceeding the results of the conventional biocide-containing primers of Table 5. All inventive examples display a solidification capability greater 13.5 g. In summary, the performance of the biocide-free primers was on the same level or even better than the performance of the conventional biocide-containing primers. In particular, the solidification capability of biocide-free primers based on inventive dispersions was excellent. Also, the pH stability of all biocide-free primers based on inventive dispersions was on a very good level. After 28 days storage at 50° C., the drop in pH was at most 0.07. C24 based on Comparative Dispersion 8 exhibited the worst pH stability with a drop of 0.18 within the same timeframe.

TABLE 6
Properties of the biocide-free penetration primers 1

| | Disp. | Penetration into | | | Solidification | pH | |
|---|---|---|---|---|---|---|---|
| Primer | as per Ex. | gypsum | spruce | red cedar | of quartz sand (g) | Start | 28 d, 50° C. |
| C17¹ | C1 | 1 | 2 | 1.5 | 12.8 | 11.42 | 11.37 |
| 18 | 2 | 1 | 1.5 | 1.5 | 14.4 | 11.41 | 11.35 |
| 19 | 3 | 1 | 1 | 2 | 14.2 | 11.41 | 11.37 |
| 20 | 4 | 1 | 1 | 2 | 13.9 | 11.42 | 11.40 |
| 21 | 5 | 1 | 1.5 | 2 | 14.6 | 11.40 | 11.33 |
| 22 | 6 | 1 | 1.5 | 2 | 13.6 | 11.40 | 11.35 |
| 23 | 7 | 1 | 1.5 | 2 | 14.5 | 11.42 | 11.38 |
| C24 | C8 | 1 | 2 | 1.5 | 13.2 | 11.40 | 11.22 |

¹significant agglomerate formation upon preparation

Application results of the ‘type 2’ biocide-free penetration primers (high pH affected through addition of potassium silicate) are displayed in Table 7. In this case, primer C25 based on Comparative Dispersion 1 could be produced without issues. However, the limited compatibility of this dispersion with potassium silicate gave rise to partial coagulation of the primer after 7 days storage at room temperature. In comparison to the conventional biocide-containing primers and the ‘type 1’ biocide-free primers, the penetration ability of the ‘type 2’ biocide-free primers into gypsum was significantly deteriorated, while penetration into hard wood was excellent for all samples. The solidification capability of all samples was on an excellent level, even outperforming the results of the biocide-free primers 1. All inventive examples display a solidification capability of 15 g or greater. The pH stability of this type of biocide-free primers based on inventive dispersions was again on a very good level. After 28 days storage at 50° C., the drop in pH was at most 0.06. In line with the results for the biocide-free primers of type 1, C32 based on Comparative Dispersion 8 exhibited the worst pH stability with a drop of 0.11 within the same timeframe.

TABLE 7
Properties of the biocide-free penetration primers 2

| | Disp. | Penetration into | | | Solidification | pH | |
|---|---|---|---|---|---|---|---|
| Primer | as per Ex. | gypsum | spruce | red cedar | of quartz sand (g) | Start | 28 d, 50° C. |
| C25¹ | Cl | 5 | 2 | 1 | 14.8 | 11.27 | 11.22 |
| 26 | 2 | 4 | 1.5 | 1 | 15.0 | 11.22 | 11.16 |
| 27 | 3 | 4 | 1 | 1 | 15.5 | 11.21 | 11.17 |
| 28 | 4 | 4 | 2 | 1 | 15.0 | 11.20 | 11.16 |
| 29 | 5 | 3.5 | 2 | 1 | 15.8 | 11.20 | 11.14 |
| 30 | 6 | 3.5 | 2 | 1 | 15.8 | 11.18 | 11.16 |
| 31 | 7 | 4 | 2 | 1 | 16.5 | 11.19 | 11.20 |
| C32 | C8 | 4 | 2 | 1 | 15.0 | 11.22 | 11.11 |

¹partial coagulation after storage for 7 days at room temperature

### Examples 33-56 (Inventive and Comparative Wood Stains)

Conventional biocide-containing wood stains were prepared by mixing the ingredients in Table 8 at room temperature under stirring (Ex. 33-40). Biocide-free wood stains were obtained through addition of potassium methyl siliconate (pos. 8) and consecutive adjustment of the pH to 11.0-11.5 through addition of 10 wt. % caustic soda (Ex. 41-48). A second class of biocide-free primers was obtained through addition of potassium silicate (pos. 9) and consecutive adjustment of the pH through addition of caustic soda (Ex. 49-56).

TABLE 8
Compositions of the wood stains

| | | | Biocide-contain. | Biocide-free | Biocide-free |
|---|---|---|---|---|---|
| | | | wood stain | wood stain 1 | wood stain 2 |
| | | | (Ex. 33-40) | (Ex. 41-48) | (Ex. 49-56) |
| Pos. | Ingredient | Supplier | parts per weight | | |
| 1 | Dispersion per Ex. 1-8¹ | | 308 | 308 | 308 |
| 2 | Calgon ® N, 10% in water | ICL | 1 | 1 | 1 |
| 3 | Tego ® Foamex 805 N | Evonik | 1 | 1 | 1 |
| 4 | Water | | 150 | 150 | 150 |
| 5 | Luconyl ® Orange 2416² | BASF | 25 | 25 | 25 |
| 6 | Colanyl Black N 530² | Clariant | 0.13 | 0.13 | 0.13 |
| 7 | Colanyl Violet LR 530² | Clariant | 0.75 | 0.75 | 0.75 |
| 8 | Silres ® BS 168 | Wacker | | 9 | |
| 9 | Betolin K 28 | Wöllner | | | 35 |

¹The solid contents of all polymer dispersions were adjusted to 32.0% before their addition.
²Pigment preparations to color the wood stain in teak

### Application Tests

Wood stains protect and enhance the aesthetical appearance of the substrate. A desired feature of transparent wood stains is the accentuation of the wood grain. To test the accentuation of the wood grain, the wood stain was applied twice onto spruce with a brush. After drying, the accentuation was qualitatively assessed by visual inspection, and rated from 1 (=very good) to 6 (=very bad).

The wood stains shall protect the substrate from environmental influences. When subjected to water for an extended period of time, the wood may be prone to discoloration, either due to water whitening or due to water penetrating into the substrate. Water whitening is an optical phenomenon which is caused by the hydration of hydrophilic parts of the polymeric binder when a coated substrate is immersed in or wetted with water. Hydration changes the refractive index of these parts and leads to light scattering at the interfaces of hydrated and non-hydrated domains. Penetration of water into the substrate, on the other hand, causes wood to darken. To test the magnitude of discoloration upon water exposure, the wood stain was applied twice onto spruce with a brush. After drying for 24 hours at room temperature, approximately 0.5 mL DI water were dripped onto one spot of the dry film. After 30 min, the water spot was removed, and the magnitude of discoloration was assessed by visual inspection and rated from 1 (no optical change) to 6 (strong discoloration).

As for the biocide-free primers, the pH stability of the biocide-free wood stains was tested at elevated temperature (50° C.) to accelerate chemical processes and to limit storage time.

### Application Results

Application results of conventional biocide-containing wood stains are summarized in Table 9. Both concerning discoloration upon water exposure and accentuation of the wood grain, the performance of the inventive dispersions was on a similar level as that of the comparative dispersions.

TABLE 9
Properties of the biocide-containing wood stains

| | Disp. | Discoloration | Accentuation |
|---|---|---|---|
| Wood | as per | (after 30 min | of wood |
| stain | Ex. | water exposure) | grain |
| C33 | C1 | 1 | 3 |
| C34 | 2 | 2 | 2 |
| C35 | 3 | 1 | 2 |
| C36 | 4 | 1 | 2 |
| C37 | 5 | 2 | 2 |
| C38 | 6 | 1 | 2 |
| C39 | 7 | 1 | 1-2 |
| C40 | C8 | 1 | 2 |

Application results of the ‘type 1’ biocide-free wood stains (high pH affected through addition of potassium methyl siliconate) are summarized in Table 10. Due to the limited compatibility of Comparative Dispersion 1 with potassium methyl siliconate, wood stain C41 completely coagulated during preparation. Concerning discoloration upon water exposure, the performance of the biocide-free wood stains according to formulation 1 was on a similar level as that of the conventional biocide-containing wood stains C33-C40. On average, the accentuation of the wood grain was slightly less pronounced for wood stains 42-47 than that of the biocide-containing wood stains C34-C39. The pH stability of the wood stains according to formulation 1 based on inventive dispersions was on an acceptable level. After 28 days storage at 50° C., the drop in pH is at most 0.22. Wood stain C48 based on Comparative Dispersion 8 exhibited the worst pH stability with a drop of 0.48 within the same timeframe. Overall, the application performance of all biocide-free wood stains according to formulation 1 was on an acceptable or better level.

TABLE 10
Properties of the biocide-free wood stains 1

| | Disp. | Discoloration | Accentuation | pH | |
|---|---|---|---|---|---|
| Wood | as per | (after 30 min | of wood | | 28 d, |
| stain | Ex. | water exposure) | grain | Start | 50° C. |
| C41¹ | C1 | Complete coagulation upon preparation | | | |
| 42 | 2 | 1 | 3 | 11.29 | 11.23 |
| 43 | 3 | 2 | 3 | 11.27 | 11.15 |
| 44 | 4 | 1 | 3 | 11.36 | 11.17 |
| 45 | 5 | 1 | 3 | 11.35 | 11.13 |
| 46 | 6 | 2 | 3 | 11.31 | 11.19 |
| 47 | 7 | 1 | 2-3 | 11.29 | 11.15 |
| C48 | C8 | 1 | 3 | 11.72 | 11.24 |

Application results of the ‘type 2’ biocide-free wood stains (high pH affected through addition of potassium silicate) are summarized in Table 11. Due to the limited compatibility of Comparative Dispersion 1 with potassium silicate, wood stain C49 could not be prepared. Both concerning accentuation of wood grain and discoloration upon water exposure, the performance of the biocide-free wood stains according to formulation 2 is on a similar level as that of the conventional biocide-containing wood stains C33-C40. The pH stability of the wood stains according to formulation 2 based on inventive dispersions is on a very good level. After 28 d storage at 50° C., the drop in pH is at most 0.07. Wood stain C56 based on Comparative Dispersion 8 exhibits the worst pH stability with a drop of 0.14 within the same timeframe. Overall, the application performance of all biocide-free wood stains according to formulation 2 is on a good or better level.

TABLE 11
Properties of the biocide-free wood stains 2

| | Disp. | Discoloration | Accentuation | pH | |
|---|---|---|---|---|---|
| Wood | as per | (after 30 min | of wood | | 28 d, |
| stain | Ex. | water exposure) | grain | Start | 50° C. |
| C49¹ | C1 | Complete coagulation upon preparation | | | |
| 50 | 2 | 2 | 2 | 11.16 | 11.15 |
| 51 | 3 | 1 | 2 | 11.18 | 11.12 |
| 52 | 4 | 1 | 2 | 11.23 | 11.16 |
| 53 | 5 | 2 | 2 | 11.19 | 11.12 |
| 54 | 6 | 2 | 2 | 11.23 | 11.16 |
| 55 | 7 | 2 | 1-2 | 11.22 | 11.18 |
| C56 | C8 | 1 | 2 | 11.21 | 11.07 |

In summary, the performance of the biocide-free formulations is about equal or even better than that of the conventional biocide-containing ones. Noteworthy is the excellent binding capability of the biocide-free penetration primers. Comparative dispersion 1 without any strong acid monomer suffers from insufficient compatibility with the high pH buffers potassium silicate and potassium methyl siliconate, either leading to limited storage stability of the biocide-free formulations or even making their preparation impossible. Comparative dispersion 8, also not comprising any strong acid monomer, is sufficiently compatible with potassium methyl siliconate and potassium silicate to enable the formulation of biocide-free primers and wood stains. However, the high VOC content of this dispersion does not allow formulations with low emission profiles to be manufactured. Further, the pH stability of biocide-free formulations based on this dispersion is significantly worse than that of all biocide-free formulations based on inventive dispersions. Only the inventive dispersions comprising both strong and weak acid monomers offer biocide-free penetration primers and wood stains with good performance, good stability, and low VOC values to be formulated.

The following numbered embodiments are contemplated. All combinations of features and embodiments are contemplated.

Embodiment 1: A penetration primer or wood stain formulation, comprising: a) an aqueous polymer dispersion comprising a polymer produced by free-radically initiated emulsion polymerization of an ethylenically unsaturated strong acid monomer with a pKa less than 4 (in water at 20° C.) and an ethylenically unsaturated weak acid monomer with a pKa of 4 or greater (in water at 20° C.); and b) at least one water-soluble alkali metal silicate, at least one water-soluble alkali metal or alkaline earth metal alkyl siliconate, or a mixture thereof.

Embodiment 2: The formulation according to Embodiment 1, wherein the formulation is free of biocides.

Embodiment 3: The formulation according to Embodiment 1 or 2, wherein the formulation has a pH from 10 to 12, preferably from 10.5 to 11.5.

Embodiment 4: The formulation according to any of the preceding Embodiments, wherein the weight-average particle size of the aqueous polymer dispersion is less than 100 nm, preferably less than 80 nm, or more preferably less than 60 nm, as measured by capillary hydrodynamic fractionation.

Embodiment 5: The formulation according to any of the preceding Embodiments, wherein the at least one ethylenically unsaturated strong acid monomer is present in an amount from 0.5 to 5 wt. %, preferably from 0.7 to 4.5 wt. %, more preferably from 0.8 to 4.0 wt. %, most preferably from 1.0 to 3.5 wt. %, based on the weight of all monomers used in producing the polymer.

Embodiment 6: The formulation according to any of the preceding Embodiments, wherein the at least one ethylenically unsaturated strong acid monomer comprises a sulfonic acid or a salt thereof.

Embodiment 7: The formulation according to any of the preceding Embodiments, wherein the at least one ethylenically unsaturated strong acid monomer comprises vinyl sulfonic acid or 2-acrylamido-2-methylpropanesulfonic acid or an alkali metal or ammonium salt thereof.

Embodiment 8: The formulation according to any of the preceding Embodiments, wherein the at least one unsaturated strong acid monomer comprises 2-acrylamido-2-methylpropanesulfonic acid or an alkali metal or ammonium salt thereof.

Embodiment 9: The formulation according to any of the preceding Embodiments, wherein the ethylenically unsaturated weak acid monomer is present in an amount from 1 to 10 wt. %, preferably from 1.5 to 8 wt. %, more preferably from 2 to 7 wt. %, most preferably from 2.5 to 6 wt. %, based on the weight of all monomers used in producing the polymer.

Embodiment 10: The formulation according to any of the preceding Embodiments, wherein the at least one ethylenically unsaturated weak acid monomer is selected from the group consisting of an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, and combinations thereof.

Embodiment 11: The formulation according to any of the preceding Embodiments, wherein the at least one ethylenically unsaturated weak acid monomer comprises methacrylic acid, acrylic acid, or combinations thereof.

Embodiment 12: The formulation according to any of the preceding Embodiments, wherein the ethylenically unsaturated weak acid monomer comprises at least two ethylenically unsaturated weak acid monomers.

Embodiment 13: The formulation according to any of the preceding Embodiments, wherein the polymer is additionally formed from at least one hard block-building monomer having a glass transition temperature of the corresponding homopolymer of greater than 25° C. and at least one soft block-building monomer having a glass transition temperature of the corresponding homopolymer of less than 25° C.

Embodiment 14: The formulation according to Embodiment 13, wherein the hard block-building monomer comprises styrene.

Embodiment 15: The formulation according to Embodiment 13, wherein the hard block-building monomer comprises methyl methacrylate and styrene.

Embodiment 16: The formulation according to any of claims 13-15, wherein the soft block-building monomer comprises 2-ethylhexyl acrylate.

Embodiment 17: The formulation according to any of the preceding claims, wherein the monomer mixture used to form the polymer does not comprise methacrylamide and/or acrylamide.

Embodiment 18: The formulation according to any of the preceding Embodiments, wherein the glass transition temperature of the polymer is 15° C. or lower, preferably from −15° C. to 10° C., more preferably from −10 to 5° C., as determined by differential scanning calorimetry according to ISO 16805 (2005).

Embodiment 19: The formulation according to any of the preceding Embodiments, wherein the formulation has a minimum film forming temperature of less than 5° C., preferably less than 1° C.

Embodiment 20: The formulation according to any of the preceding Embodiments, where the aqueous polymer dispersion has a Total Volatile Organic Compound (TVOC) content less than 1800 ppm, preferably less than 1500 ppm, more preferably less than 1000 ppm, as determined by gas chromatography according to ISO 11890-2 (2020).

Embodiment 21: The formulation according to any of the preceding Embodiments, wherein the formulation is free of organic solvent, plasticizer, and/or coalescent agent.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A penetration primer or wood stain formulation, comprising:
a) an aqueous polymer dispersion comprising a polymer produced by free-radically initiated emulsion polymerization of an ethylenically unsaturated strong acid monomer with a pKa less than 4 (in water at 20° C.) and an ethylenically unsaturated weak acid monomer with a pKa of 4 or greater (in water at 20° C.); and
b) at least one water-soluble alkali metal silicate, at least one water-soluble alkali metal or alkaline earth metal alkyl siliconate, or a mixture thereof.

2. The formulation according to claim 1, wherein the formulation is free of biocides.

3. The formulation according to claim 1, wherein the formulation has a pH from 10 to 12.

4. The formulation according to claim 1, wherein the weight-average particle size of the aqueous polymer dispersion is less than 100 nm as measured by capillary hydrodynamic fractionation.

5. The formulation according to claim 1, wherein the at least one ethylenically unsaturated strong acid monomer is present in an amount from 0.5 to 5 wt. %, based on the weight of all monomers used in producing the polymer.

6. The formulation according to claim 1, wherein the at least one ethylenically unsaturated strong acid monomer comprises a sulfonic acid or a salt thereof.

7. The formulation according to claim 1, wherein the at least one ethylenically unsaturated strong acid monomer comprises vinyl sulfonic acid or 2-acrylamido-2-methylpropanesulfonic acid or an alkali metal or ammonium salt thereof.

8. The formulation according to claim 1, wherein the at least one unsaturated strong acid monomer comprises 2-acrylamido-2-methylpropanesulfonic acid or an alkali metal or ammonium salt thereof.

9. The formulation according to claim 1, wherein the ethylenically unsaturated weak acid monomer is present in an amount from 1 to 10 wt. %, based on the weight of all monomers used in producing the polymer.

10. The formulation according to claim 1, wherein the at least one ethylenically unsaturated weak acid monomer is selected from the group consisting of an ethylenically unsaturated C₃-C₈ monocarboxylic acid, an ethylenically unsaturated C₄-C₈ dicarboxylic acid, an ethylenically unsaturated C₄-C₈ dicarboxylic acid anhydride, and combinations thereof.

11. The formulation according to claim 1, wherein the at least one ethylenically unsaturated weak acid monomer comprises methacrylic acid, acrylic acid, or combinations thereof.

12. The formulation according to claim 1, wherein the ethylenically unsaturated weak acid monomer comprises at least two ethylenically unsaturated weak acid monomers.

13. The formulation according to claim 1, wherein the polymer is additionally formed from at least one hard block-building monomer having a glass transition temperature of the corresponding homopolymer of greater than 25° C. and at least one soft block-building monomer having a glass transition temperature of the corresponding homopolymer of less than 25° C.

14. The formulation according to claim 13, wherein the hard block-building monomer comprises styrene or a combination of methyl methacrylate and styrene.

15. The formulation according to claim 13, wherein the soft block-building monomer comprises 2-ethylhexyl acrylate.

16. The formulation according to claim 1, wherein the monomer mixture used to form the polymer does not comprise methacrylamide and/or acrylamide.

17. The formulation according to claim 1, wherein the glass transition temperature of the polymer is 15° C. or lower, as determined by differential scanning calorimetry according to ISO 16805 (2005).

18. The formulation according to claim 1, wherein the formulation has a minimum film forming temperature of less than 5° C., preferably less than 1° C.

19. The formulation according to claim 1, where the aqueous polymer dispersion has a Total Volatile Organic Compound (TVOC) content less than 1800 ppm, as determined by gas chromatography according to ISO 11890-2 (2020).

20. The formulation according to claim 1, wherein the formulation is free of organic solvent, plasticizer, and/or coalescent agent.
